(19) United States
(12) Patent Application Publication
(10) Pub. No.: US 2023/0358317 A1
(43) Pub. Date: Nov. 9, 2023

(54) VALVE FOR COMPRESSED GAS WITH ACTUATING DEVICE OPERABLE BY A ROBOTIC INTERFACE

(71) Applicant: ROTAREX S.A., Lintgen (LU)

(72) Inventors: Guillaume MASSIN, Helsdorf (LU); Phillppe SCHMITZ, Steinsel (LU); Paul MUZZO, Yut (FR)

(21) Appl. No.: 18/245,468

(22) PCT Filed: Sep. 15, 2021
(86) PCT No.: PCT/EP2021/075317

§ 371 Date: Mar. 15, 2023

(30) Foreign Application Priority Data
Sep. 15, 2020 (LU) LU102078

(51) Int. Cl. F16K 1/30; F16K 37/00; F16K 31/122; F16K 35/02

(52) U.S. Cl. CPC F16K 1/302; F16K 37/0058; F16K 31/1225; F16K 31/1221; F16K 35/027

(57) ABSTRACT

A valve for compressed gas, comprising: a body with an inlet, an outlet and a passage interconnecting the inlet and with outlet; a shut-off device with a shutter mobile in translation along a longitudinal axis of the valve for cooperating with a seat in the passage, the shutter being urged by one or more elastic elements against the seat so as to normally close the passage; an actuating device configured to convert a pressure into a lifting movement of the shutter off the seat so as to open the passage; wherein the actuating device comprises an external circular flange or groove extending around the longitudinal axis and configured for being engaged by a robotic interface providing the pressure to the actuating device.

### CROSS-REFERENCE TO RELATED APPLICATIONS

The present invention is the US national stage under 35 U.S.C. § 371 of International Application No. PCT/EP2021/075317 which was filed on Sept. 15, 2021, and which claims the priority of application LU102078 filed on Sept. 15, 2020 the contents of which (text, drawings and claims) are incorporated here by reference in its entirety.

### FIELD

The invention is directed to the field of valves for compressed gas, in particular valves to be mounted on compressed gas cylinders.

### BACKGROUND

Prior art patent document published WO 01/44703 A2 discloses a valve for compressed gas, to be mounted on the neck of a cylinder containing the compressed gas. The valve comprises a shutter that is urged by a stack of Belleville spring washers against the seat so as to be normally closed. The valve comprises an actuating device consisting of three pistons arranged side by side along a central spindle holding the shutter and located in independent chambers that are all fed by a central fluid inlet on the central spindle. The actuating forces exerted by each piston on the spindle are cumulative and thereby sufficiently high for counteracting the elastic force of the stack of Belleville spring washers.

Prior art patent document published WO 2016/096436 A1 discloses a valve for compressed gas, to be mounted on the neck of a cylinder containing the compressed gas and similar to the one of the preceding document. The shutter is held by an actuating element that is urged by a stack of Belleville spring washers towards the seat, so that the valve is normally closed. The valve comprises a pneumatic and hydraulic actuating device, i.e., consisting of a piston with a larger portion in a upper chamber fed by compressed air and a smaller portion delimiting with the actuating element and the body a lower chamber filled with an incompressible fluid like oil and forming a force multiplication unit able to lift the actuating element and thereby the shutter off the seat against the resilient force of the stack of Belleville spring washers. Restriction means for the incompressible fluid are provided for slowing down the transfer from one portion to the other portion of the lower chamber and thereby achieving a slow opening of the valve.

For gases which are dangerous for the human health, e.g., gases used the production of semiconductors (like dopant gases such as arsine and phosphine and etching gases), it might be desirable to have an automated replacement of the gas cylinders. In addition to transportation and manipulation of the gas cylinders, this implies shutting-off and disconnecting the gas cylinder to be replaced, and thereafter connecting the new gas cylinder and opening the valve. Such operations require specific adaptations of the valve.

Prior art patent document published GB 2 168 787 A discloses a remote actuating system for a valve used to supply uranium hexafluoride being a radioactive dangerous gas. The system provides an adaptor to be securely mounted onto the valve and a socket provided with a bayonet connection engaging the adaptor. Once the bayonet connection is properly engaged with the adaptor on the valve, the latter can be operated by engagement of a non-circular socket with a corresponding valve operating element and remote rotation thereof. That system provides a high level of security. It is however not designed and suitable for a robotic engagement. In addition, it is mechanically complex.

### SUMMARY

The invention has for technical problem to overcome at least one drawback of the above cited prior art. More specifically, the invention has for technical problem to facilitate an automated replacement of gas cylinders at a gas consumption station.

The invention is directed to a valve for compressed gas, comprising: a body with an inlet, an outlet and a passage interconnecting the inlet and with outlet; a shut-off device with a shutter mobile in translation along a longitudinal axis of the valve for cooperating with a seat in the passage, the shutter being urged by one or more elastic elements against the seat so as to normally close the passage; an actuating device configured to convert a pressure into a lifting movement of the shutter off the seat so as to open the passage; wherein the actuating device comprises an external circular flange or groove extending around the longitudinal axis and configured for being engaged by a robotic interface providing the pressure to the actuating device.

According to an exemplary embodiment, the actuating device comprises, relative to the longitudinal axis, a proximal half-portion and a distal half-portion, the external circular flange or groove being formed or attached to the distal half-portion.

According to an exemplary embodiment, the actuating device comprises a fluid port or a tappet for receiving the pressure from the robotic interface, the fluid port or tappet being centred with the external circular flange or groove.

According to an exemplary embodiment, the port or tappet of the actuating device is configured to be engaged by the robotic interface by a translational movement along the longitudinal axis.

According to an exemplary embodiment, the fluid port or tappet of the actuating device is located on a distal outer face of the actuating device, that is transversal to the longitudinal axis.

According to an exemplary embodiment, the external circular flange or groove comprises an annular inner surface that is perpendicular to the longitudinal axis or positively tapers relative to a plane perpendicular to the longitudinal axis, so as to form a positive contact surface for engagement by locking elements of the robotic interface.

According to an exemplary embodiment, the actuating device comprises a locking device movable from a locked position preventing the shut-off device from being opened to an unlocked position allowing the shut-off device to be opened, and vice versa, the locking device comprising an actuating element located on a distal outer face of the actuating device, that is transversal to the longitudinal axis so as to be engaged by the robotic interface.

According to an exemplary embodiment, the actuating element of the locking device is movable in rotation around the longitudinal axis and shows an outer surface that is noncircular or with at least one indent so as to be engaged in rotation by the robotic interface.

According to an exemplary embodiment, the actuating element of the locking device is formed by the circular flange.

According to an exemplary embodiment, the locking device is configured to, in the locked position, mechanically engage with the shutter of the shut-off device in order to prevent the lifting movement of the shutter off the seat.

According to an exemplary embodiment, the locking device comprises a rotatable element threadably engaged with the body so as to, upon rotation, move in translation along the longitudinal axis and prevent the lifting movement of the shutter off the seat.

According to an exemplary embodiment, the fluid port or tappet extends longitudinally through the rotatable element of the locking device.

According to an exemplary embodiment, the valve comprises a cap fitted on the actuating device, attached to the rotatable element of the locking device and carrying the circular flange.

According to an exemplary embodiment, the cap with the circular flange is a moulded unitary single piece.

According to an exemplary embodiment, the cap comprises a cylindrical wall surrounding the actuating device and provided with a least one aperture configured for selectively rendering visible indicia on an outer surface of the actuating device in the locked position and/or unlocked position.

According to an exemplary embodiment, the actuating device is pneumatic and comprises at least two pistons side by side around a spindle carrying the shutter and housed in independent chambers configured to be fed with the pressure by a common fluid inlet.

According to an exemplary embodiment, the actuating device is hydraulic and configured to convert movement of a tappet caused by the pressure into the lifting movement of the shutter of a shorter stroke and higher force.

The invention is also directed to a robotic interface for engaging with an actuating device of a valve according to invention, wherein the robotic interface comprises a cap-shaped housing configured for being axially slipped on the actuating device; at least one radial locking device for engaging with the external circular groove of the actuating device; and a piston housed in the cap-shaped housing and configured for, upon actuation, exert the pressure on the actuating device so as to open the passage.

According to an exemplary embodiment, the at least one radial locking device comprises two of the radial locking devices arranged in a diametrically opposed fashion.

According to an exemplary embodiment, each of the at least one radial locking device comprises a pneumatically actuatable pin for selectively engaging with the external circular groove of the actuating device.

The invention is particularly interesting in that it provides a valve that is particularly adapted and designed for being operated by a robotic interface. Movements of a robotic arm with a robotic interface for automatically operating the valve are subject to errors and inherently show limitations in positioning accuracy. It is therefore important to provide robust engaging means on the valve for the robotic interface, i.e., engagement means that are reliable and compensate the positioning tolerances of the robotic interface. The external circular flange or groove on the actuating device provides such robust engaging means on the valve for the robotic interface.

### DRAWINGS

FIG. 1 is an exemplary plan view of a valve for compressed gas according to a first exemplary embodiment of the invention.

FIG. 2 is another exemplary view of the valve of FIG. 1 according to various embodiments of the invention.

FIG. 3 is an exemplary top view of the valve of FIG. 2 according to various embodiments of the invention.

FIG. 4 is an exemplary schematic sectional view of a valve illustrating the construction of the valve of FIGS. 1 to 3 according to various embodiments of the invention.

FIG. 5 is an exemplary plan view of the upper part of the valve of FIGS. 1 to 4 being engaged by a robotic interface according to various embodiments of the invention.

FIG. 6 is an exemplary perspective view of a valve for compressed gas with a robotic interface, according to a second exemplary embodiment of the invention.

FIG. 7 is an exemplary partial perspective view of the robotic interface of FIG. 6 according to various embodiments of the invention.

FIG. 8 is a partial sectional view of the engagement of the robotic interface with the valve of FIGS. 6 and 7 according to various embodiments of the invention.

### DETAILED DESCRIPTION

In the following description, the concept of “distal” and “proximal”, unless specified differently, are to be understood with reference to a central or core portion of the main element that is described, for instance the valve.

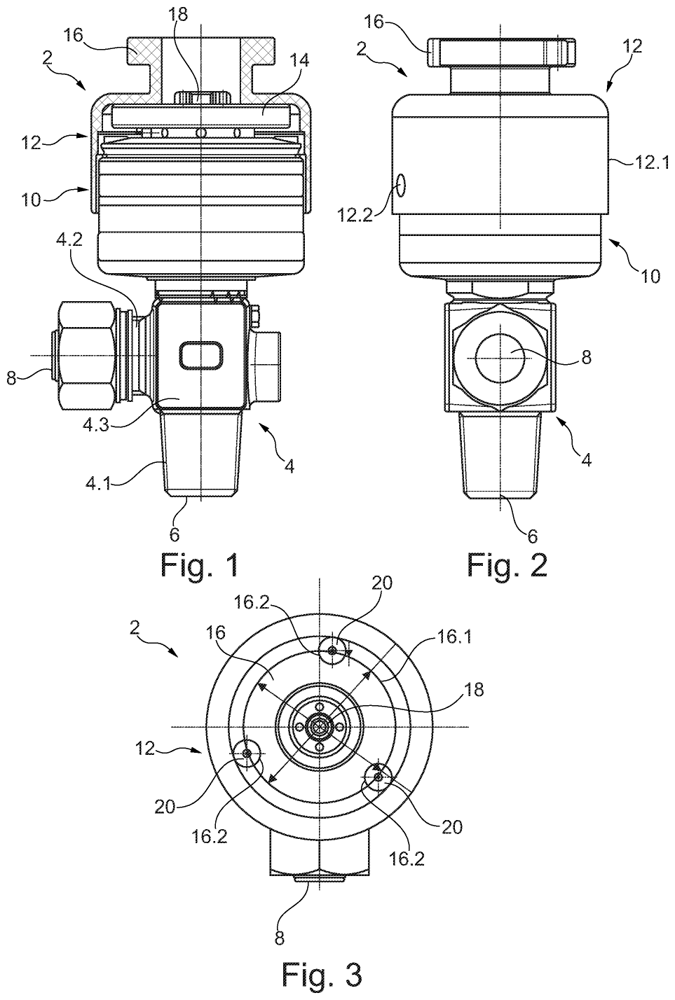

FIGS. 1 to 5 illustrate a first exemplary embodiment of the invention.

FIG. 1 shows a valve 2 for compressed gas and that is designed for being mounted on a neck or collar of a gas cylinder. The valve 2 comprises a body 4 with a male threaded portion 4.1 designed for engaging a corresponding female thread in the neck or collar of a gas cylinder (not represented). The male thread is for instance tapered as this is usual. A gas inlet 6 is provided a distal face of the male threaded portion 4.1. A gas outlet 8 is also provided on the body 4, at an outlet portion 4.2 of the body 4. A passage (not visible) fluidly interconnects the inlet 6 with the outlet 8.

A shut-off device (not visible) is provided in the body 4, for instance in the central portion 4.3 thereof. The shut-off device is designed for selectively shutting-off or closing and opening the passage fluidly interconnecting the inlet 6 with the outlet 8. The shut-off device is operated by the actuating device 10 adjacent the central portion 4.3 of the body 4. A cap 12 is fitted onto a distal half-portion of the actuating device 10 and rests on a rotatable element of a locking device 14 of the valve 2. The operation of the actuating device 10 on the shut-off device for opening the passage can be hindered by the locking device 14. The latter is movable between an unlocked position and a locked position and vice versa. In the locked position, the shut-off device which is normally closed cannot be opened by the actuating device 10. In the unlocked position, the shut-off device can be operated, for instance opened, by the actuating device 10. For instance, the locking device 14 is rotatable, being understood that it could also be operable differently, e.g., in translation.

The cap 12 comprises a circular flange 16 is at a distal end of the valve 2, above the locking device 14. The circular flange is designed for being engaged by a robotic interface for automatically selectively unlocking or locking the shut-off device of the valve 2, for instance by rotation of the circular flange 16 and therefore of the locking device 14 securely fixed thereto via the cap 12.

Still with reference to FIG. 1, the actuating device 10 is pneumatic and comprises a fluid port 18, for instance aligned with the longitudinal axis of the valve 2, where this fluid port 18 is designed for being engaged in a gas tight fashion by the robotic interface mentioned here above, in order to, only the locking device 14 is moved to its unlocked position, supply the actuating device 10 with a pressurized fluid, like compressed air, for operating the shut-off device and open the passage for the compressed gas in the gas cylinder.

FIG. 2 is another side view of the valve 2 of FIG. 1. In this view the cap 12 is not cut, contrary to FIG. 1. We can observe that the cap 12 comprises, at a proximal end, a generally cylindrical wall 12.1 that closely surrounds the outer face of the actuating device 10. That cylindrical wall 12.1 shows an aperture 12.2 that allows to selectively show indicia or any kind of marking on the outer face of the actuating device 10, in the locked and unlocked positions of the locking device 14. Such indicia or markings are not visible in FIG. 2, due to the lateral position of the aperture 12.2. It is however clear that dots or surface of difference colours, e.g., green for the unlocked position and red for the locked position, or vice versa depending on the security-related purpose of the marking, can be provided at locations that correspond to these locked and unlocked positions.

FIG. 3 is a top view of the valve 2 of FIGS. 1 and 2, oriented according to FIG. 2. The flange 16 shows a circular outer face 16.1 provided with indents 16.2, for instance three indents 16.2 distributed evenly around the circular outer face 16.1. These indents 16.2 allow the above mentioned robotic interface to engage in rotation with the flange 16 so as to rotate the flange 16 and the cap 12 for selectively locking or unlocking the shut-off device of the valve. The indents 16.2 are for instance circular, i.e., portions of circles aligned with screws 20 fastening the cap 12 to the locking device 14 (FIG. 1). Thanks to the indents 16.2, the screws 20 can be easily engaged parallel with the longitudinal axis.

The flange 16 shows also an annular inner surface 16.3 that is perpendicular to the longitudinal axis and allows an engagement in the axial direction by the robotic interface 32.

Still with reference with FIG. 3, we can observe the fluid port 18 at the centre of the valve 2, more particularly of the cap 12 and of the flange 16. The fluid part can show an inner thread for being engaged by a nipple protruding distally from the fluid port, where the nipple is specifically designed or selected for engaging in a gas tight fashion with a corresponding nipple or contact surface on the robotic interface. It is understood that various solutions for providing such an engagement with a gas tight connection are possible and within the scope of the skilled person.

The cap 12 can be moulded and be a unitary element. It can be made of composite material comprising fibres, e.g., glass fibres, and a resin like nylon PA6.6.

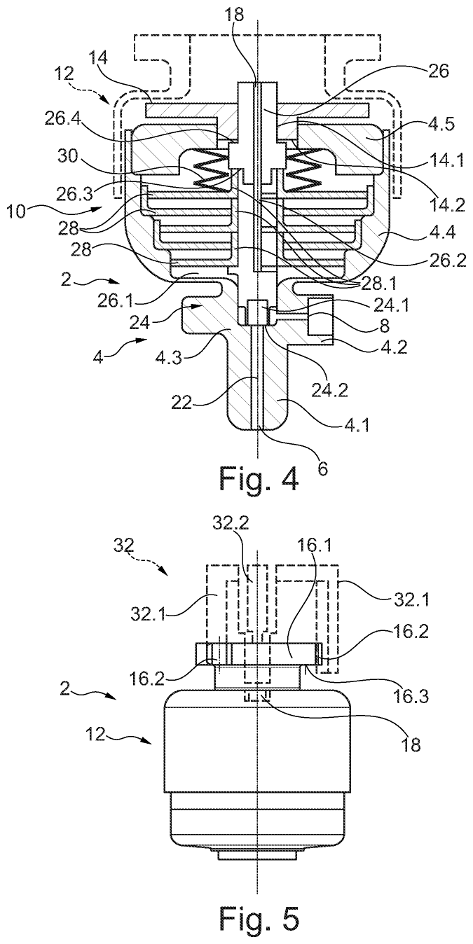

FIG. 4 is a schematic sectional view of a valve similar to the valve 2 of FIGS. 1 to 3, illustrating the functioning principle.

As this is apparent, the passage 22 formed in the body 4 fluidly interconnects the inlet 6 with the outlet 8. The shut-off device 24 comprises a shutter 24.1 that is movable in translation, for instance along the longitudinal axis, and a seat 24.2 surrounding the passage 22. The seat 24.2 can be directly formed in the body 4 as illustrated or formed as part that is placed and fastened in the body 4. The shutter 24.1 is carried by a central spindle 26 that movable in translation along the longitudinal axis. A plurality of pistons 28 are fitted around the central spindle 26 and arranged side by side. In the present exemplary embodiment, the number of pistons is three but it is to be understood that the number of pistons could be different, e.g., 1, 2, 4 or even more. The lower piston 28 rests on a lower protrusion 26.1 of the central spindle 28, forming an abutting surface. Each piston 28 comprises a sleeve portion 28.1 fitted around the central spindle 26 and abutting against each other, in a stacked manner. Each piston is slidingly received in a specific chamber formed in the housing portion 4.4 of the body 4. It is understood that this housing portion can be integrally formed with the central portion 4.3 of the body 4 or attached thereto, e.g., by screwing means. A stack of Belleville spring washers 30 is fitted around the central spindle 26 and rests, at an upper end, on a cover plate 4.5 attached to the housing portion 4.4 of the body 4 and, at a lower end on the upper piston 28. The stack of Belleville spring washers 30 is preloaded so that it exerts a compressive axial force on the stacked pistons 28 and, via the protrusion 26.1 of the central spindle 28, to the central spindle 26 and the shutter 24.1 against the seat 24.2. The shut-off device 24 is thereby normally closed.

Upon application of a fluid pressure via the fluid port 18 on the central spindle 26, the fluid pressure is distributed via the channel 26.3 formed the central spindle 26 to the different chambers of the pistons 28. Each piston 28 is urged upwardly by the fluid pressure and transmits the resulting force via the sleeve portions 28.1 to the central spindle 26 via the lower abutment 26.3. The forces of the difference pistons are cumulated because the chambers are independent, i.e., the upper faces of the pistons are at the atmospheric pressure. The resulting force oriented distally lifts the central spindle 26 and the shutter 24.1 off the seat 24.2 so as to open the passage 22 between the inlet 6 and outlet 8. The above principle is as such known from the skilled person and therefore does not need to be further detailed.

The locking device 14 is formed essentially by a rotating element surrounding the central spindle 26 and with a thread 14.1 engaged with a corresponding thread on the body 4, for instance the cover plate 4.5 of the body 4. This means that rotating the locking device around the longitudinal axis moves the device in translation along the axis. A lower surface 14.2 of the locking device can then contact an upper abutment 26.4 of the central spindle and force the central spindle 26.4 and the shutter 24.1 in a lower and closed position.

The threaded engagement between the locking device 14 and the body 4 can be optimized by selecting an appropriate pitch that provides a sufficient translational movement for a given rotation angle, ideally less than a complete turn (i.e.,360°), while producing a sufficient but also not too high pressing force on the central spindle 26 and shutter 24.1.

FIG. 5 illustrates an exemplary robotic interface 32 in engagement with the valve 2 of FIGS. 1-4.

The robotic interface 32 is represented in dashed lines and shows three fingers 32.1 in engagement with the indents 16.2 formed on the outer face 16.1 of the flange 16 and a central fluid supply 32.2 in engagement with the fluid port 18. Upon rotation of the robotic interface 32, the cap 12 and thereby the locking device (not visible) are rotated. In the case of a new and filled gas cylinder, the locking device is during transportation in a locked position. Once the gas cylinder is properly position in a cabinet of the gas consumption installation and the outlet of the valve is properly connected to an inlet conduit of the installation, the robotic interface 32 is moved into engagement with the valve 2, as illustrated in FIG. 5. It is then rotated so as to move the locking device from the locked position to an unlocked position. Thereafter a pressurized fluid, like compressed air, can be fed through the fluid supply 32.2 to the fluid port 18 of the actuating device so as to open the passage in the valve 2.

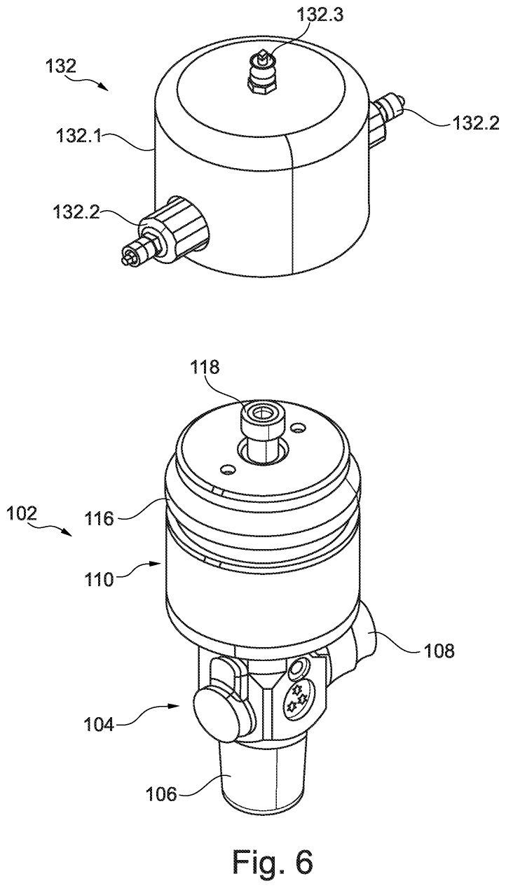

FIGS. 6 to 8 illustrate a second exemplary embodiment of the invention. The reference numbers of the first exemplary embodiment are used for designating the same or corresponding elements, these numbers being however incremented of 100. It is also referred to the description of these elements in connection with the first exemplary embodiment. Specific reference numbers comprises between 100 and 200 are used for designating specific elements.

FIG. 6 is a perspective view of the valve 102 and of a corresponding robotic interface 132.

The valve 102 differs from the valve 2 of the first exemplary embodiment essentially in that the actuating device is not pneumatic but hydraulic, configured for converting a downward movement of a tappet 118, i.e., in the proximal direction, into a lifting movement of the shutter (not visible) off the seat (not visible) so as to open the passage.

The hydraulic construction of the valve 102 for converting a pushing movement of the tapper 118 into a lifting movement of the shutter (not visible) off the seat (not visible) can be achieved by an actuating element forms a first piston slidingly received in a housing so as to delimit with the housing an auxiliary chamber containing an incompressible fluid, like oil. A shutter of the shut-off device is attached to the actuating element. The tappet is mechanically linked to a second piston that is slidingly received through the actuating element and delimits also the auxiliary chamber. The second piston shows an effective cross-sectional surface in contact with the incompressible fluid that is less than the effective cross-sectional surface of the first piston formed by the actuating element. A pushing movement of the tappet 118 causes then a corresponding penetration of the first piston into the second piston, thereby increasing the pressure in the auxiliary chamber where the increase of pressure causes a lifting movement of the second piston formed by the actuating element. Such a construction is as such known from the skilled person and does not therefore need to be further detailed.

The above hydraulic construction is exemplary, being understood that other constructions and other mechanisms achieving the same function can be considered.

The valve 102 differs from the valve 2 of the first exemplary embodiment also in that it comprises no locking device. Important is to note that a locking device can be present, for instance similar to the one of the first exemplary embodiment.

The actuating device 110 shows an external circular groove 116 that can be engaged by the robotic interface 132. The latter comprises a cap-shaped housing 132.1 that is designed for being axially slid on the actuating device 110, two radial locking devices 132.2 for engaging with the external circular groove 110, and a piston housed in the cap-shaped housing 13.2.1 and configured for, upon supply of pressurized fluid via the port 132.3, exert a pressure on the tappet 118 of the actuating device 110 so as to open the passage.

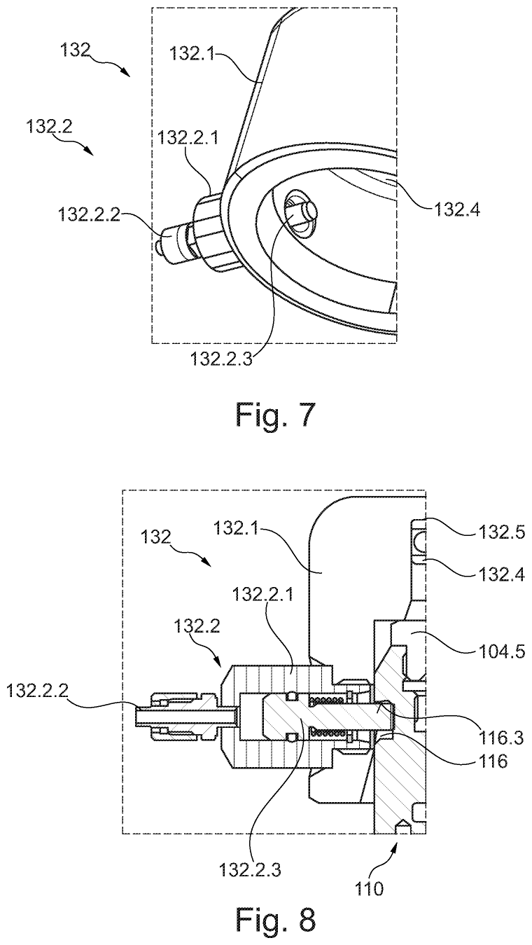

FIGS. 7 and 8 are partial sectional views of the robotic interface of FIG. 6, alone, and the robotic interface in engagement with the valve of FIG. 6, respectively.

The cap-shaped housing 132.1 of the robotic interface 132 houses in a slidably fashion a piston 132.4 that forms a chamber 132.5 that can be fed with pressurized fluid, e.g., compressed air, for urging the piston 132.4 distally, i.e., towards the opening of the cap-shaped housing 132.1.

Each radial locking device 132.2 comprises a housing 132.2.1 with a fluid inlet 132.2.2 and a chamber housing a pin 132.2.3 that, upon application of a pressurized fluid in the chamber via the fluid inlet 132.2.2, is urged radially towards the external circular groove 116.

In operation, once the robotic interface 132, more specifically the cap-shaped housing 132.1, is axially slid on the actuating device 110, the radial locking devices 132.2 are supplied with the pressurized fluid, for instance compressed air, so that the respective pins 132.2.3 engage in the external circular groove 116. As that stage, the robotic interface 132 is axially secured to the actuating device 110. The chamber 132.5 can then be supplied with the pressurized fluid, for instance compressed air, via the corresponding port 132.3 in order to move the piston 132.4 downwardly, i.e., towards the opening of the cap-shaped housing 132.1, until it contacts and moves the tappet 118 (FIG. 6) and opens the valve.

Specifically with reference to FIG. 8, the external circular groove 116 comprises an annular inner surface 116.3 that is generally perpendicular to the longitudinal axis and, more precisely, that positively tapers relative to a plane perpendicular to the longitudinal axis, so as to form a positive contact surface for engagement with the pins 132.2.3 of the radial locking devices 132.2 of the robotic interface 132. By positively tapering and forming a positive contact surface, it is meant that the inclination of the annular inner surface 116.1 is such that it geometrically increases or at least does not reduce the mechanical engagement with the pins 132.2.3 in the axial direction.

1.-20. (canceled)

21. A valve for compressed gas, said valve comprising:
a body with an inlet, an outlet and a passage interconnecting the inlet and with outlet;
a shut-off device with a shutter mobile in translation along a longitudinal axis of the valve for cooperating with a seat in the passage, the shutter being urged by one or more elastic elements against the seat so as to normally close the passage;
an actuating device configured to convert a pressure into a lifting movement of the shutter off the seat so as to open the passage;
wherein the actuating device comprises an external circular flange or groove extending around the longitudinal axis and configured for being engaged by a robotic interface providing the pressure to the actuating device.

22. The valve according to claim 21, wherein the actuating device comprises, relative to the longitudinal axis, a proximal half-portion and a distal half-portion, the external circular flange or groove being formed or attached to the distal half-portion.

23. The valve according to claim 21, wherein the actuating device comprises a fluid port or a tappet for receiving the pressure from the robotic interface, the fluid port or tappet being centred with the external circular flange or groove.

24. The valve according to claim 23, wherein the fluid port or tappet of the actuating device is configured to be engaged by the robotic interface by a translational movement along the longitudinal axis.

25. The valve according to claim 23, wherein the fluid port or tappet of the actuating device is located on a distal outer face of the actuating device, that is transversal to the longitudinal axis.

26. The valve according to claim 21, wherein the external circular flange or groove comprises an annular inner surface that is perpendicular to the longitudinal axis or positively tapers relative to a plane perpendicular to the longitudinal axis, so as to form a positive contact surface for engagement by locking elements of the robotic interface.

27. The valve according to claim 21, wherein the actuating device comprises a locking device movable from a locked position preventing the shut-off device from being opened to an unlocked position allowing the shut-off device to be opened, and vice versa, the locking device comprising an actuating element located on a distal outer face of the actuating device, that is transversal to the longitudinal axis so as to be engaged by the robotic interface.

28. The valve according to claim 27, wherein the actuating element of the locking device is movable in rotation around the longitudinal axis and shows an outer surface that is noncircular or with at least one indent so as to be engaged in rotation by the robotic interface.

29. The valve according to claim 28, wherein the actuating element of the locking device is formed by the circular flange.

30. The valve according to claim 27, wherein the locking device is configured to, in the locked position, mechanically engage with the shutter of the shut-off device in order to prevent the lifting movement of the shutter off the seat.

31. The valve according to claim 27, wherein the locking device comprises a rotatable element threadably engaged with the body so as to, upon rotation, move in translation along the longitudinal axis and prevent the lifting movement of the shutter off the seat.

32. The valve according to claims 31, wherein the actuating device comprises a fluid port or tappet for receiving the pressure from the robotic interface and extending longitudinally through the rotatable element of the locking device.

33. The valve according to claim 31, comprising a cap fitted on the actuating device, attached to the rotatable element of the locking device and carrying the circular flange.

34. The valve according to claim 33, wherein the cap with the circular flange is a moulded unitary single piece.

35. The valve according to claim 33, wherein the cap comprises a cylindrical wall surrounding the actuating device and provided with a least one aperture configured for selectively rendering visible indicia on an outer surface of the actuating device in the locked position and/or unlocked position.

36. The valve according to claim 21, wherein the actuating device is pneumatic and comprises at least two pistons side by side around a spindle carrying the shutter and in independent chambers configured to be fed with the pressure by a common fluid inlet.

37. The valve according to claim 21, wherein the actuating device is hydraulic and configured to convert movement of the tappet caused by the pressure into the lifting movement of the shutter of a shorter stroke and higher force.

38. A robotic interface for engaging with an actuating device of a valve for compressed gas, said valve comprising:
a body with an inlet, an outlet and a passage interconnecting the inlet and with outlet;
a shut-off device with a shutter mobile in translation along a longitudinal axis of the valve for cooperating with a seat in the passage, the shutter being urged by one or more elastic elements against the seat so as to normally close the passage;
an actuating device configured to convert a pressure into a lifting movement of the shutter off the seat so as to open the passage;
wherein the actuating device comprises an external circular flange or groove extending around the longitudinal axis and configured for being engaged by a robotic interface providing the pressure to the actuating device;
wherein the robotic interface comprises:
a cap-shaped housing configured for being axially slipped on the actuating
device;
at least one radial locking device for engaging with the external circular groove
of the actuating device; and
a piston housed in the cap-shaped housing and configured for, upon actuation,
exert the pressure on the actuating device so as to open the passage.

39. The robotic interface according to claim 38, wherein the at least one radial locking device comprises two of the radial locking devices arranged in a diametrically opposed fashion.

40. The robotic interface according to claim 38, wherein each of the at least one radial locking device comprises a pneumatically actuatable pin for selectively engaging with the external circular groove of the actuating device.
